(19) United States
(12) Patent Application Publication
(10) Pub. No.: US 2026/0196567 A1
(43) Pub. Date: Jul. 9, 2026

(54) LITHIUM SECONDARY BATTERY ELECTROLYTE FOR HIGH-SPEED CHARGING, AND LITHIUM SECONDARY BATTERY COMPRISING SAME

(71) Applicant: The Industry & Academic Cooperation in Chungnam National University (IAC), Daejeon (KR)

(72) Inventors: Seung-Wan Song, Sejong (KR); Hyeongyu Lee, Cheongju-si (KR)

(73) Assignee: The Industry & Academic Cooperation in Chungnam National University (IAC), Daejeon (KR)

(21) Appl. No.: 19/553,910

(22) Filed: Mar. 2, 2026

Related U.S. Application Data
(63) Continuation-in-part of application No. PCT/KR2024/017262, filed on Nov. 5, 2024.

(30) Foreign Application Priority Data
Nov. 7, 2023 (KR) 10-2023-0152424

(51) Int. Cl. H01M 10/0569; H01M 10/052; H01M 10/0567; H01M 10/0568; H01M 10/42

(52) U.S. Cl. CPC H01M 10/0569; H01M 10/052; H01M 10/0567; H01M 10/0568; H01M 10/4235; H01M 2300/0034; H01M 2300/0037

(57) ABSTRACT

A high-safety lithium secondary battery electrolyte for high-speed charging, according to the present invention, comprises a linear carbonate solvent and a linear sulfate solvent including fluorine at the end thereof, and thus exhibits non-flammability and is suitable for high-speed charging.

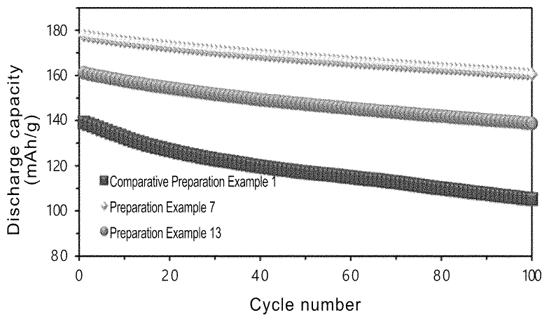

### TECHNICAL FIELD

The present disclosure relates to a non-flammable lithium secondary battery electrolyte capable of exhibiting excellent performance even under high-speed charging conditions, and a lithium secondary battery including the same.

### BACKGROUND ART

Lithium secondary batteries are among the most widely used energy storage systems at present, and is generally consisting of a cathode, an anode, a separator, and an electrolyte. Of these components, the electrolyte typically employs a non-aqueous organic electrolyte having lithium-ion conductivity. However, such non-aqueous organic electrolytes are vulnerable to fire hazards. In particular, the integration and capacity expansion of lithium secondary batteries has led to a rise in hazardous accidents, including fires or explosions, which may significantly threaten both human lives and property safety.

Especially for batteries used in electric vehicles, the demand for which has increased rapidly in recent years, the risk of fire and explosion is further amplified. Accordingly, various attempts have continuously been made to overcome these issues and secure safety.

Meanwhile, with the trend toward higher capacity in secondary batteries, battery charge/discharge speeds have become critical factors that directly dictate usage efficiency and user satisfaction. However, high-speed charging and discharging of conventional secondary batteries often leads to a significant challenge in rapid capacity retention degradation.

Korean Patent No. 10-2417211 discloses a non-flammable electrolyte for lithium secondary batteries. However, such non-flammable electrolytes also face limitations in exhibiting sufficient durability during high-speed charging. Accordingly, there is a need to develop a secondary battery that exhibits non-flammability while maintaining excellent capacity retention even under high-speed charging conditions.
(Patent Document) Korean Patent Np. 10-2417211

### DISCLOSURE

### Technical Problem

An objective of the present disclosure is to provide a lithium secondary battery electrolyte that exhibits non-flammability while securing high capacity retention during high-speed charging, thereby being suitable for high-speed charging.

### Technical Solution

A lithium secondary battery electrolyte for high-speed charging according to the present disclosure may include: a lithium salt;
a first solvent satisfying Chemical Formula 1 below; and
a second solvent satisfying Chemical Formula 2 below:

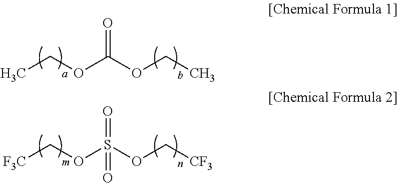

wherein, in Chemical Formula 1 above, a and b may each independently be 0 or an integer from 1 to 5, and in Chemical Formula 2, m and n may each independently be 0 or an integer from 1 to 5)

In the lithium secondary battery electrolyte for high-speed charging according to one embodiment of the present disclosure, the lithium salt may be one or at least two selected from the group consisting of LiPF₆, LiClO₄, LiASF₆, LiBF₄, LiSbF₆, LiAlO₄, LiAlCl₄, LiCF₃SO₃, LiCAF₉SO₃, LiC₆H₅SO₃, LiN(C₂F₅SO₃)₂, LiN(C₂F₅SO₂)₂/LiN(CF₃SO₂)₂, LiN(FSO₂)₂, LiN(CₓF₂ₓ₊₁SO₂)(C_{y}F_{2y+1}SO₂) (wherein x and y are 0 or natural numbers), LiCl, LiI, LiSCN, LiB(C₂O₄)₂, LiF₂BC₂O₄, LiPF₄(C₂O₄), LiPF₂(C₂O₄)₂, and LiP(C₂O₄)₃.

In the lithium secondary battery electrolyte for high-speed charging according to one embodiment of the present disclosure, the first solvent and the second solvent are mixed at a volume ratio of 20:80 to 78:22.

In the lithium secondary battery electrolyte for high-speed charging according to one embodiment of the present disclosure, the lithium salt may be included at a concentration of 0.1 to 5 M.

In the lithium secondary battery electrolyte for high-speed charging according to one embodiment of the present disclosure, in Chemical Formula 1 above, a and b may each independently be 0, 1, or 2, and, in Chemical Formula 2 above, m and n may each independently be 0, 1, or 2.

In the lithium secondary battery electrolyte for high-speed charging according to one embodiment of the present disclosure, the lithium secondary battery electrolyte may further include: at least one additive selected from vinylene carbonate and vinyl ethylene carbonate.

In the lithium secondary battery electrolyte for high-speed charging according to one embodiment of the present disclosure, the additive may be included in an amount of 0.01 to 4 wt % based on a total weight of the electrolyte.

In the lithium secondary battery electrolyte for high-speed charging according to one embodiment of the present disclosure, the lithium secondary battery electrolyte may have a viscosity of 1.9 to 3 cP at 25° C.

In the lithium secondary battery electrolyte for high-speed charging according to one embodiment of the present disclosure, a battery including the lithium secondary battery electrolyte may have a capacity retention of 80% or higher after 100 charge-discharge cycles at a charge-discharge rate of 3 C.

In the lithium secondary battery electrolyte for high-speed charging according to one embodiment of the present disclosure, the lithium secondary battery electrolyte may have a self-extinguishing time (SET) of less than 6 seconds.

The present disclosure further provides a lithium secondary battery. The lithium secondary battery according to the present disclosure may include: the lithium secondary battery electrolyte for high-speed charging according to one embodiment; a cathode; an anode; and a separator.

### Advantageous Effects

By including a lithium salt; a first solvent satisfying Chemical Formula 1 below; and a second solvent satisfying Chemical Formula 2 below, the lithium secondary battery electrolyte for high-speed charging according to the present disclosure can exhibit non-flammability while securing high capacity retention even under high-speed charging conditions.

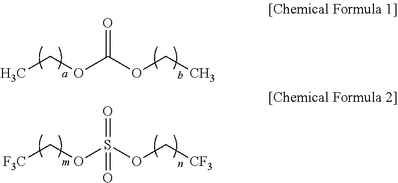

### DESCRIPTION OF DRAWINGS

The FIGURE illustrates results comparing capacity retention as a function of cycle number for batteries to which electrolytes prepared according to Preparation Examples of the present disclosure are applied.

### MODE FOR INVENTION

The advantages and features of the embodiments and the ways of accomplishing them will become apparent from the following detailed description of exemplary embodiments in conjunction with the accompanying drawings. The disclosure, however, may be embodied in many different forms and should not be constructed as being limited to the embodiments set forth herein. Rather, these embodiments are provided so that this disclosure will be thorough and complete and will fully convey the scope to those skilled in the art. The scope of the embodiments of the present disclosure should be defined by the claims. Throughout the drawings, the same reference numerals will refer to the same or like parts.

In describing the embodiments of the present disclosure, when it is determined that detailed description of related known functions or configurations unnecessarily obscures the gist of the present disclosure, the detailed description thereof will be omitted. Further, the terminologies to be described below are defined in consideration of functions in the embodiments of the present disclosure, which may vary depending on a user's or an operator's intention or practice. Accordingly, the definition thereof may be made on the basis of the content throughout the specification.

A lithium secondary battery electrolyte for high-speed charging according to the present disclosure includes a lithium salt;
a first solvent satisfying Chemical Formula 1 below; and
a second solvent satisfying Chemical Formula 2 below.

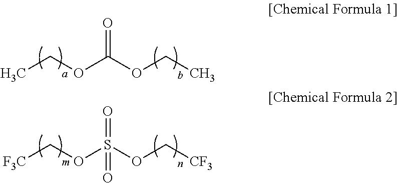

In Chemical Formula 1 above, a and b are each independently an integer of 0 or from 1 to 5, and in Chemical Formula 2 above, m and n are each independently an integer of 0 or from 1 to 5.

The lithium secondary battery electrolyte for high-speed charging according to the present disclosure employs, as an electrolyte solvent, a mixture composed of a linear carbonate-based solvent represented by Chemical Formula 1 and a fluorinated linear sulfate-based solvent represented by Chemical Formula 2. This enables the electrolyte to secure non-flammability while retaining excellent capacity retention even during repeated high-speed charging.

Preferably, a and b in Chemical Formula 1 and m and n in Chemical Formula 2 are each independently selected from 0, 1, or 2. By satisfying these ranges for a, b, m, and n, the electrolyte can prevent excessive increases in viscosity while providing favorable physicochemical properties in battery applications.

The volume ratio of the first solvent to the second solvent may range from 20:80 to 78:22. Within this range, the electrolyte can maintain low viscosity while exhibiting non-flammable characteristics.

In the lithium secondary battery electrolyte for high-speed charging according to embodiment of the present disclosure, the lithium salt may be one or at least two selected from the group consisting of LiPF₆, LiClO₄, LiASF₆, LiBF₄, LiSbF₆, LiAlO₄, LiAlCl₄, LiCF₃SO₃, LiCAF₉SO₃, LiC₆H₅SO₃, LiN(C₂F₅SO₃)₂, LiN(C₂F₅SO₂)₂, LiN(CF₃SO₂)₂, LiN(FSO₂)₂, LiN(CₓF₂ₓ₊₁SO₂)(C_{y}F_{2y+1}SO₂) (wherein x and y are 0 or natural numbers), LiCl, LiI, LiSCN, LiB(C₂O₄)₂, LiF₂BC₂O₄, LiPF₄(C₂O₄), LiPF₂(C₂O₄)₂, and LiP(C₂O₄)₃. Preferably, the lithium salt may be one or at least two selected from LiPF₆, LiClO₄, LiAsF₆, LiBF₄, LiSbF₆, LiAlO₄, and LiAlCl₄, and more preferably LiPF₆. In this case, the lithium salt may be included at a concentration of 0.1 to 5 M, preferably 0.5 to 2 M.

The lithium secondary battery electrolyte for high-speed charging according to the embodiment of the present disclosure may further include at least one additive selected from vinylene carbonate and vinyl ethylene carbonate. The addition of such additives promotes the formation of a solid electrolyte interface (SEI) layer, thereby improving cycle life in battery applications. The additive may be included in an amount of 0.01 to 4 wt %, preferably 0.5 to 3 wt %, based on the total weight of the lithium secondary battery electrolyte. Within this range, the battery can exhibit high discharge capacity while maintaining excellent durability.

The lithium secondary battery electrolyte for high-speed charging according to the embodiment of the present disclosure may have a viscosity of 1.8 to 3 cP, preferably 2 to 2.5 cP, at 25° C. Within this range of viscosity, high ionic conductivity and excellent battery performance can be achieved. Specifically, as a result of charge-discharge testing of a secondary battery employing the lithium secondary battery electrolyte for high-speed charging according to the embodiment of the present disclosure, the battery exhibits a capacity retention of at least preferably 85 to 95% after 3 charge-discharge cycles at 3 C, compared to that obtained at 0.1 C. Additionally, when the secondary battery employing the lithium secondary battery electrolyte is charged and discharged at 3 C, an initial discharge capacity of at least 180 mAh/g, specifically 185 to 200 mAh/g, can be achieved. After 100 charge-discharge cycles at 3 C, the capacity retention relative to the initial capacity remains at least 80%, preferably 83% to 90%. Due to such high durability, excellent battery performance can be maintained over an extended period even during high-speed charging. Furthermore, the lithium secondary battery electrolyte according to the embodiment of the present disclosure satisfies non-flammability characteristics, exhibiting a self-extinguishing time (SET) of less than 6 seconds, thereby providing enhanced safety in battery applications.

The present disclosure further provides a lithium secondary battery. The lithium secondary battery according to the present disclosure may include the lithium secondary battery electrolyte according to the embodiment of the present disclosure, a cathode, an anode, and a separator. As described above, the lithium secondary battery according to the present disclosure employs an electrolyte using a solvent mixture composed of a linear carbonate-based solvent represented by Chemical Formula 1 and a fluorinated linear sulfate-based solvent represented by Chemical Formula 2, thereby exhibiting high discharge capacity and excellent capacity retention.

More specifically, the lithium secondary battery may include: a cathode including a cathode active material; an anode including an anode active material; a non-flammable electrolyte for the lithium secondary battery; and a separator.

In further detail, the lithium secondary battery may include: a cathode including a cathode active material; an anode including an anode active material; a lithium salt; the lithium secondary battery electrolyte for high-speed charging according to the embodiment of the present disclosure as described above; and a separator.

The cathode, the anode, and the separator are not particularly limited and may be those commonly used in the art. Specifically, in one example of the present disclosure, the cathode active material included in the cathode may be selected from the group consisting of LiCoO₂, LiMnO₂, LiNiO₂, LiNi₁₋ₓCoₓO₂, LiNi_{1-x-y}CoₓMn_{y}O₂, LiNi_{1-x-y}CoₓM_{y}O₂ (wherein M is a divalent or trivalent metal or a transition metal), wLi₂MnO₃·(1-w)LiNi_{1-x-y}CoₓM_{y}O₂, LiMn₂₋ₓMₓO₄ (wherein M is a transition metal), LiFePO₄, LiMnPO₄, LiCoPO₄, LiFe₁₋ₓMₓPO₄ (wherein M is a transition metal), Li_{1.2}Mn_{(0.8-a)}MaO₂ (wherein M is a divalent or trivalent metal or a transition metal), Li₂N₁₋ₓMₓO₃ (wherein N is a divalent, trivalent, or tetravalent metal or a transition metal, and M is a divalent or trivalent metal or a transition metal), Li₁₊ₓN_{y-z}M_{z}O₂ (wherein N is Ti or Nb, and M is V, Ti, Mo, or W), Li₄Mn₂₋ₓMₓO₅ (wherein M is a metal or a transition metal), LiₓM₂₋ₓO₂ (wherein M is a metal or a transition metal such as Ti, Zr, Nb, or Mn), and Li₂O/Li₂Ru₁₋ₓMₓO₃ (wherein M is a metal or a transition metal). However, these are merely illustrative examples, and any cathode active material known in the art may be used without limitation.

Additionally, the cathode may further include a conductive material and a binder. Specifically, the conductive material is used to impart electrical conductivity to the electrodes, and any material that does not cause chemical changes and has electronic conductivity may be used without particular limitation. Specific examples thereof may include graphite; carbon-based materials such as carbon black, acetylene black, Ketjen black, channel black, furnace black, lamp black, thermal black, carbon fibers, carbon nanotubes, carbon nanowires, and graphene; metal powders or metal fibers such as copper, nickel, aluminum, and silver; conductive whiskers such as zinc oxide and potassium titanate; conductive metal oxides such as titanium oxide; or conductive polymers such as polyphenylene derivatives, which may be used alone or in combination of two or more thereof. However, these are merely illustrative examples, and any conductive material known in the art may be used without limitation.

The binder serves to improve adhesion between cathode active material particles or between the cathode active material and a current collector. Specific examples thereof may include polyvinylidene fluoride (PVDF), polyimide (PI), polyacrylic acid (PAA), polyvinyl alcohol (PVA), carboxymethyl cellulose (CMC), starch, hydroxypropyl cellulose, regenerated cellulose, polyvinylpyrrolidone (PVP), tetrafluoroethylene, polyethylene, polypropylene, ethylene-propylene-diene polymer (EPDM), sulfonated EPDM, styrene-butadiene rubber, fluorine rubber, or various copolymers thereof, which may be used alone or in combination of two or more thereof. However, these are merely illustrative examples, and any binder known in the art may be used without limitation.

In one example of the present disclosure, the anode may be manufactured in a manner similar to that of the cathode, either by directly coating an anode active material onto a copper current collector, or by casting the anode active material onto a separate support to form an anode active material film, peeling the film from the support, and laminating the peeled film onto the copper current collector.

As the anode, lithium metal, a lithium alloy, or an anode active material capable of intercalating/deintercalating lithium ions may be used. Specific examples of the anode active material may include cokes, artificial graphite, natural graphite, soft carbon, hard carbon, combusted organic polymer compounds, carbon fibers, carbon nanotubes, graphene, silicon, silicon oxide, tin, tin oxide, germanium, graphite composites containing silicon, silicon oxide, tin, tin oxide, or germanium, Li₄Ti₅O₁₂, or TiO₂. However, these are merely illustrative examples, and any anode active material known in the art may be used without limitation.

In one example of the present disclosure, the separator may be formed of polyethylene, polypropylene, polyvinylidene fluoride, or a multilayer film including two or more layers thereof. Also, a separator coated with ceramic may be used. However, these are merely illustrative examples, and any separator known in the art may be used without limitation.

Meanwhile, the lithium secondary battery may be a lithium-ion secondary battery, a lithium metal secondary battery, or an all-solid-state lithium secondary battery. The lithium secondary battery may be applied to portable electronic devices such as smartphones, wearable electronic devices, power tools, electric vehicles (EVs), energy storage systems (ESS), electric two-wheeled vehicles including electric bicycles and electric scooters, and electric golf carts. Furthermore, the lithium secondary battery according to the present disclosure may be fabricated in various forms, such as prismatic, cylindrical, or pouch-type batteries, in addition to coin-type batteries.

Hereinafter, the present disclosure will be described in more detail with reference to Preparation Examples and Comparative Preparation Examples. The following examples are provided merely to facilitate understanding of the present disclosure, and the scope of the present disclosure is not limited thereto.

### Preparation Example 1

A organic solvent mixture was prepared by mixing ethyl methyl carbonate (EMC) and bis(2,2,2-trifluoroethyl) sulfate (FES) at a volume ratio of 5:5. LiPF₆ was added to the organic solvent mixture at a concentration of 1.0 M to prepare a 1.0 M LiPF₆/EMC:FES (5:5) electrolyte. As an additive, vinylene carbonate (VC) was added in an amount of 2 wt % based on the total weight of the electrolyte.

### Preparation Example 2

An electrolyte was prepared in the same manner as in Preparation Example 1, except that diethyl carbonate (DEC) was used instead of EMC.

### Preparation Example 3

An electrolyte was prepared in the same manner as in Preparation Example 1, except that dimethyl carbonate (DMC) was used instead of EMC.

### Preparation Examples 4 to 12

Electrolytes were prepared in the same manner as in Preparation Example 3, except that the mixing ratios of DMC and FES were varied as shown in Table 1 below.

### Preparation Example 13

An electrolyte was prepared in the same manner as in Preparation except that DMC, FES, and methyl(2,2,2-trifluoroethyl) carbonate (FEMC) were mixed at a volume ratio of 71:24:5.

### Comparative Preparation Example 1

An electrolyte was prepared in the same manner as in Preparation Example 1, except that ethylene carbonate (EC), EMC, and DEC were mixed at a volume ratio of 25:45:30.

### Comparative Preparation Example 2

An electrolyte was prepared in the same manner as in Preparation Example 1, except that propylene carbonate (PC), FEMC, and FES were mixed at a volume ratio of 30:55:15.

### Comparative Preparation Example 3

An electrolyte was prepared in the same manner as in Preparation Example 1, except that DMC alone was used as the organic solvent.

### Evaluation of Non-Flammability and Viscosity

For each of the electrolytes prepared according to the Preparation Examples, the self-extinguishing time (SET) and the viscosity at 25° C. were measured, and the results are summarized in Table 1 below.

Specifically, the self-extinguishing time was determined by igniting each electrolyte using a torch and measuring the self-extinguishing time (in seconds) per unit mass (g) of the electrolyte after removal of the torch. A case where the SET was less than 6 s was evaluated as “non-flammable”, a case where the SET was 6 s or more and less than 20 s was evaluated as “flame-retardant”, and a case where the SET was 20 s or more was evaluated as “flammable”.

TABLE 1

| | | | | | | Non- | |
|---|---|---|---|---|---|---|---|
| | | | | | | flammability | |
| | First | Second | Third | Fourth | Volume | (SET | Viscosity |
| | solvent | solvent | solvent | solvent | ratio | (sec/g)) | (cP) |
| Preparation | EMC | FES | — | — | 50:50 | Non- | 4.27 |
| Example 1 | | | | | | flammable | |
| | | | | | | (0) | |
| Preparation | DEC | FES | — | — | 50:50 | Non- | 4.75 |
| Example 2 | | | | | | flammable | |
| | | | | | | (0) | |
| Preparation | DMC | FES | — | — | 50:50 | Non- | 3.37 |
| Example 3 | | | | | | flammable | |
| | | | | | | (0) | |
| Preparation | DMC | FES | | | 90:10 | Flammable | 1.80 |
| Example 4 | | | | | | (62) | |
| Preparation | DMC | FES | — | — | 80:20 | Flammable | 1.99 |
| Example 5 | | | | | | (22) | |
| Preparation | DMC | FES | — | — | 78:22 | Non- | 2.04 |
| Example 6 | | | | | | flammable | |
| | | | | | | (0) | |
| Preparation | DMC | FES | — | — | 76:24 | Non- | 2.15 |
| Example 7 | | | | | | flammable | |
| | | | | | | (0) | |
| Preparation | DMC | FES | — | — | 74:26 | Non- | 2.19 |
| Example 8 | | | | | | flammable | |
| | | | | | | (0) | |
| Preparation | DMC | FES | — | — | 72:28 | Non- | 2.23 |
| Example 9 | | | | | | flammable | |
| | | | | | | (0) | |
| Preparation | DMC | FES | — | — | 70:30 | Non- | 2.71 |
| Example 10 | | | | | | flammable | |
| | | | | | | (0) | |
| Preparation | DMC | FES | — | — | 30:70 | Non- | 4.80 |
| Example 11 | | | | | | flammable | |
| | | | | | | (0) | |
| Preparation | DMC | FES | — | — | 20:80 | Non- | 5.39 |
| Example 12 | | | | | | flammable | |
| | | | | | | (0) | |
| Preparation | DMC | FES | FEMC | — | 71:24:5 | Non- | 2.34 |
| Example 13 | | | | | | flammable | |
| | | | | | | (0) | |
| Comparative | EMC | — | DEC | EC | 45:30:25 | Flammable | 3.28 |
| Preparation | | | | | | (60) | |
| Example 1 | | | | | | | |
| Comparative | FEMC | FES | — | PC | 55:15:30 | Non- | 5.7 |
| Preparation | | | | | | flammable | |
| Example 2 | | | | | | (0) | |
| Comparative | DMC | — | — | — | 100:0 | Flammable | 1.59 |
| Preparation | | | | | | (64) | |
| Example 3 | | | | | | | |

Referring to Table 1, it can be confirmed that the electrolytes employing the solvents of Comparative Preparation Examples 1 and 3 exhibit flammability. On the contrary, the electrolytes prepared according to the Preparation Examples, except for Preparation Examples 4 and 5, all exhibit non-flammability. In particular, Preparation Example 6 shows non-flammability with a self-extinguishing time of less than 6 seconds, despite containing 78 vol % of DMC, which is generally known as a flammable material. Additionally, the electrolytes of Preparation Examples 4 to 10 exhibit viscosities in the range of 1.8 to 3 cP at 25° C., whereas the electrolytes of Comparative Preparation Examples 1 and 2 exhibit relatively high viscosities of 3.28 cP and 5.7 cP, respectively.

### High-Speed Charging Performance Test 1

A 2032 coin-type lithium-ion battery (full cell) was fabricated using a high-loading graphite anode, a LiNi_{0.88}Co_{0.08}Mn_{0.04}O₂ cathode (active material loading per area: 18 mg/cm²), each of the electrolytes prepared according to Preparation Example 7, Preparation Example 13, and Comparative Preparation Example 1, and a separator (ceramic-coated polyethylene (PE), MS-PCS 15).

For the lithium-ion battery including the above electrolyte, charge-discharge cycling was performed over a voltage range of 2.7 to 4.2 V with C-rates of 0.1 C (10 h charging), 0.2 C (5 h charging), 0.5 C (2 h charging), 1 C (1 h charging), 2 C (30 min charging), and 3 C (20 min charging). After 3 cycles at each C-rate, the capacity retention relative to that obtained at 0.1 C charging was calculated. The results are summarized in Table 4 below.

$$Capacity retention ( \% ) = ( average discharge capacity over 3 cycles at each C - rate / average discharge capacity over 3 cycles at 0.1 C \times 100$$

TABLE 2
High-speed charging performance test 1 of
graphite/LiNi_{0.88}Co_{0.08}Mn_{0.04}O₂
lithium-ion batteries

| | 0.1 C | 0.2 C | 0.5 C | 1 C | 2 C | 3 C |
|---|---|---|---|---|---|---|
| Preparation | 100 | 96 | 92 | 90 | 89 | 88 |
| Example 7 | | | | | | |
| Preparation | 100 | 92 | 88 | 85 | 84 | 83 |
| Example 13 | | | | | | |
| Comparative | 100 | 82 | 88 | 84 | 82 | 81 |
| Preparation | | | | | | |
| Example 1 | | | | | | |

As shown in Table 2 above, it can be confirmed that the electrolytes prepared according to Preparation Examples 7 and 13 exhibit improved high-speed charging performance under high c-rate conditions compared to the electrolyte of Comparative Preparation Example 1. In particular, the electrolyte of Preparation Example 7 demonstrates the most superior high-speed charging performance. Specifically, for the lithium-ion battery including the electrolyte of Preparation Example 7, the capacity retention relative to that at 0.1 C satisfies 88% to 93% after 3 charge-discharge cycles at 1 C, 86% to 91% at 2 C, and 85% to 91% at 3 C. These results indicate that, the use of the electrolyte according to the present disclosure enables stable high-speed charging in high-energy-density batteries incorporating commercially relevant high-loading graphite anodes.

### High-Speed Charging Cycle Test

A 2032 coin-type lithium-ion battery (full cell) was fabricated using a high-loading graphite anode, a LiNi_{0.88}Co_{0.08}Mn_{0.04}O₂ cathode (active material loading per area: 18 mg/cm²), each of the electrolytes prepared according to Preparation Example 7, Preparation Example 13, and Comparative Preparation Example 1, and a separator (ceramic-coated polyethylene (PE)).

For the lithium-ion battery including the above electrolyte, charge-discharge cycling was performed over a voltage range of 2.7 to 4.2 V under high c-rate conditions of 3 C (20 min charging). After 100 cycles, the specific gravimetric discharge capacity was measured, and the capacity retention relative to the initial discharge capacity was calculated. The results are summarized in Table 5 below.

$$Capacity retention ( \% ) = ( discharge capacity at the 100 th cycle ( 3 C ) / discharge capacity at the 1 st cycle ( 3 C ) \times 100$$

TABLE 3

High-speed charging cycle test of graphite/
LiNi_{0.88}Co_{0.08}Mn_{0.04}O₂ lithium-ion batteries

| | Discharge capacity | Capacity retention |
|---|---|---|
| | at 1st cycle | at 100th cycle |
| | (3C) (mAh/g) | (3C) (%) |
| Preparation | 190 | 85 |
| Example 7 | | |
| Preparation | 162 | 86 |
| Example 13 | | |
| Comparative | 139 | 76 |
| Preparation | | |
| Example 1 | | |

As shown in Table 3 above, it can be confirmed that the electrolytes prepared according to Preparation Examples 7 and 13 exhibit improved discharge capacity and capacity retention characteristics under high c-rate conditions 3 (20 min charging) compared to the of C electrolyte of Comparative Preparation Example 1. Of these, especially in the case of the electrolyte of Preparation Example 7, the highest discharge capacity and capacity retention are achieved. Specifically, the battery employing the electrolyte of Preparation Example 7 exhibits an initial discharge capacity of at least 180 mAh/g, and maintains a capacity retention of 85% or higher even after 100 charge-discharge cycles.

These results demonstrate that the use of the low-viscosity electrolyte according to the present disclosure enhances cycle life in high-energy-density batteries incorporating commercially relevant high-loading graphite anode during high-speed charging cycling. That is, compared to Comparative Preparation Example 1 employing a cyclic solvent, the electrolyte using a linear fluorinated sulfate and a linear carbonate solvent exhibits significantly improved high-speed charging cycle performance at a lower viscosity.

1. A lithium secondary battery electrolyte for high-speed charging, the lithium secondary battery electrolyte comprising:
a lithium salt;
a first solvent satisfying Chemical Formula 1 below; and
a second solvent satisfying Chemical Formula 2 below: 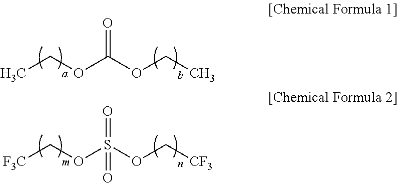
wherein, in Chemical Formula 1 above, a and b are each independently 0 or an integer from 1 to 5, and
in Chemical Formula 2 above, m and n are each independently 0 or an integer from 1 to 5.

2. The lithium secondary battery electrolyte of claim 1, wherein the lithium salt is one or at least two selected from the group consisting of LiPF₆, LiClO₄, LiAsF₆, LiBF₄, LiSbF₆, LiAlO₄, LiAlCl₄, LiCF₃SO₃, LiC₄F₉SO₃, LiC₆H₅SO₃, LiN(C₂F₅SO₃)₂, LiN(C₂F₅SO₂)₂, LiN(CF₃SO₂)₂, LiN(FSO₂)₂, LiN(CₓF₂ₓ₊₁SO₂)(C_{y}F_{2y+1}SO₂) (wherein x and y are 0 or natural numbers), LiCl, LiI, LiSCN, LiB(C₂O₄)₂, LiF₂BC₂O₄, LiPF₄(C₂O₄), LiPF₂(C₂O₄)₂, and LiP(C₂O₄)₃.

3. The lithium secondary battery electrolyte of claim 1, wherein the first solvent and the second solvent are mixed at a volume ratio of 20:80 to 78:22.

4. The lithium secondary battery electrolyte of claim 1, wherein the lithium salt is included at a concentration of 0.1 to 5 M.

5. The lithium secondary battery electrolyte of claim 1, wherein, in Chemical Formula 1 above, a and b are each independently 0, 1, or 2, and,
in Chemical Formula 2 above, m and n are each independently 0, 1, or 2.

6. The lithium secondary battery electrolyte of claim 1, further comprising:
at least one additive selected from vinylene carbonate and vinyl ethylene carbonate.

7. The lithium secondary battery electrolyte of claim 6, wherein the additive is included in an amount of 0.01 to 4 wt % based on a total weight of the electrolyte.

8. The lithium secondary battery electrolyte of claim 1, wherein the lithium secondary battery electrolyte has a viscosity of 1.9 to 3 cP at 25° C.

9. The lithium secondary battery electrolyte of claim 1, wherein a battery including the lithium secondary battery electrolyte has a capacity retention of 80% or higher after 100 charge-discharge cycles at a charge-discharge rate of 3 C.

10. The lithium secondary battery electrolyte of claim 1, wherein the lithium secondary battery electrolyte has a self-extinguishing time (SET) of less than 6 seconds.

11. A lithium secondary battery, comprising:
the lithium secondary battery electrolyte of claim 1;
a cathode;
an anode; and
a separator.

12. A lithium secondary battery, comprising:
the lithium secondary battery electrolyte of claim 2;
a cathode;
an anode; and
a separator.

13. A lithium secondary battery, comprising:
the lithium secondary battery electrolyte of claim 3;
a cathode;
an anode; and
a separator.

14. A lithium secondary battery, comprising:
the lithium secondary battery electrolyte of claim 4;
a cathode;
an anode; and
a separator.

15. A lithium secondary battery, comprising:
the lithium secondary battery electrolyte of claim 5;
a cathode;
an anode; and
a separator.

16. A lithium secondary battery, comprising:
the lithium secondary battery electrolyte of claim 6;
a cathode;
an anode; and
a separator.

17. A lithium secondary battery, comprising:
the lithium secondary battery electrolyte of claim 7;
a cathode;
an anode; and
a separator.

18. A lithium secondary battery, comprising:
the lithium secondary battery electrolyte of claim 8;
a cathode;
an anode; and
a separator.

19. A lithium secondary battery, comprising:
the lithium secondary battery electrolyte of claim 9;
a cathode;
an anode; and
a separator.

20. A lithium secondary battery, comprising:
the lithium secondary battery electrolyte of claim 10;
a cathode;
an anode; and
a separator.
